(19) United States
(12) Patent Application Publication
(10) Pub. No.: US 2004/0204043 A1
(43) Pub. Date: Oct. 14, 2004

(54) Information apparatus with interactive scent interface

(76) Inventors: Hwai-Ming Wang, Taipei City (TW); Yao-Chon Tsai, Taipei City (TW); Feng-Zen Wu, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 10/065,569

(22) Filed: Oct. 31, 2002

(30) Foreign Application Priority Data
Aug. 29, 2002 (TW) 091119724

(51) Int. Cl. H04B 1/38; H04M 1/00

(52) U.S. Cl. 455/556.1; 455/575.1; 455/90.1

(57) ABSTRACT

An information processing apparatus with an interactive scent interface comprises a housing, a processing module installed in the housing for controlling the information processing apparatus, an input module installed in the housing and electrically connected to the processing module for receiving input signals to generate corresponding control signals and for transmitting the corresponding control signals to the processing module. A display device is installed in the housing and electrically connected to the processing module for transforming information transmitted from the processing module into video data and for displaying the video data. A scent control circuit is also installed in the housing and electrically connected to the processing module for generating a scent control signal and a scent releasing module is installed in the housing and electrically connected to the scent control module for releasing scent particles according to the scent control signal.

### BACKGROUND OF INVENTION

1. Field of the Invention

The invention relates to a mobile phone, a personal digital assistant (PDA), or a notebook computer, and more particularly, to an information processing apparatus with an interactive scent interface.

2. Description of the Prior Art

Nowadays, all kinds of information, data, and documents can be quickly and conveniently stored, managed, and broadcasted in digital form. Therefore, various types of information processing apparatuses for storing digital data have become imperative bases in our information society. In accordance with recent technical developments, the size and weight of the information processing apparatuses have been reduced significantly allowing them to be easily carried with the users. Many apparatuses, including mobile phones, personal digital assistants (PDA), or notebook computers are widely used. Thus, the users can access data, deliver messages, and exchange information and knowledge anytime and anywhere.

Because the market for the information processing apparatus is aimed at common people, the design of the interface between users and the apparatus has to be user-friendly to provide fun and convenience of use. For instance, the information processing apparatus is generally designed with a display device that provides graphic images as the interface between the users and the apparatus. Moreover, users can be reminded to receive messages and calls from a mobile phone by various ringing tones or by vibrations. In other words, we can make use of the tactile senses or hearing as the interface between the users and the apparatus. However, human sensory perception goes far beyond vision, hearing, and a tactile sense. Furthermore, one can get much more fun from all his sensory organs than only from his eyes, ears, and tactile organs. Therefore, the above-mentioned prior art, which only takes sense of vision, hearing, and touching as the interface between the users and the apparatus, lacks fun and friendliness for users.

### SUMMARY OF INVENTION

It is therefore a primary objective of the claimed invention to provide an information processing apparatus with an interactive scent interface to solve the above-mentioned problem of the prior art and to enrich the users” perceptive experiences.

According to the claimed invention, the information processing apparatus comprises a housing, a processing module installed in the housing for controlling the information processing apparatus, an input module installed in the housing and electrically connected to the processing module for receiving input signals to generate corresponding control signals and for transmitting the corresponding control signals to the processing module. A display device is installed in the housing and electrically connected to the processing module for transforming information transmitted from the processing module into video data and for displaying the video data. A scent control circuit is also installed in the housing and electrically connected to the processing module for generating a scent control signal and a scent releasing module is installed in the housing and electrically connected to the scent control module for releasing scent particles according to the scent control signal, such that a user can smell scent corresponding to the scent particles.

It is an advantage of the claimed invention that the information processing apparatus practically accomplishes the interactive scent interface with a scent releasing module so that the users can be reminded of the functions of the information by the scent when operating the information processing apparatus. Thus, the interface of the information processing apparatus will be more user-friendly and diverse.

These and other objectives of the present invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a functional block diagram of a mobile phone according to the present invention.

FIG. 2 is an externally schematic diagram of the mobile phone shown in FIG. 1.

FIG. 3 is a functional block diagram of another mobile phone according to the present invention.

FIG. 4 is an externally schematic diagram of the mobile phone shown in FIG. 3.

FIG. 5 is a functional block diagram of a computer according to the present invention.

FIG. 6 is an externally schematic diagram of the computer shown in FIG. 5.

### DETAILED DESCRIPTION

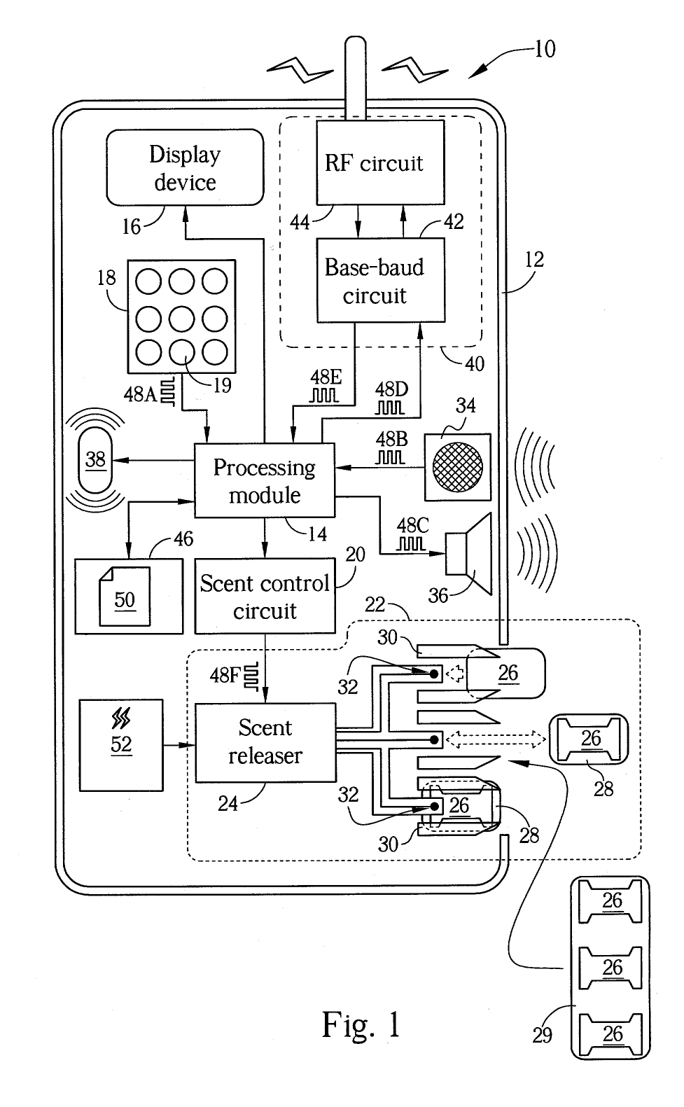

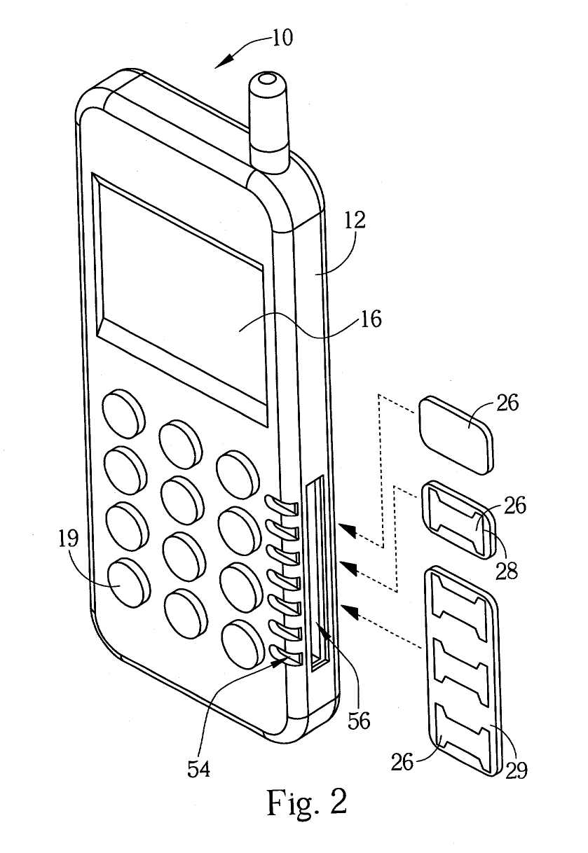

Please refer to FIG. 1 and FIG. 2. FIG. 1 is a functional schematic diagram of a mobile phone 10 according to essence of the present invention. FIG. 2 is an externally schematic diagram of the mobile phone 10. The housing 12 externally covers the mobile phone 10. As a wireless information processing apparatus, the mobile phone 10 comprises a processing module 14, a wireless communication module 40, a display device 16, an input module 18, a microphone 34, a speaker 36, and a power supply circuit 52. For accomplishing the interactive scent interface of this invention, a scent control circuit 20 and a scent releasing module 22 are installed in the mobile phone 10. A prior art vibration module 38 can be optionally added to the mobile phone 10 as an interface between the users and the apparatus. Moreover, a memory device 46, such as flash RAM, can be installed in the mobile phone 10 for storing the information related to the operations of the mobile phone 10. The power supply circuit 52 is designed for supplying the power to operate the above-mentioned functional schematic blocks. For clarity in the diagram, the relationship of electrical connection between the power supply circuit 52 and the scent releasing module 22 is simplified.

The processing module 14 is designed for controlling the operations of the mobile phone 10 and is electrically connected to the display device 16, the input module 18, the wireless communication module 40, the microphone 34, the speaker 36, the vibration module 38, the memory device 46, and the scent control circuit 20 for controlling the operations of those functional schematic blocks. The input module 18, which can be designed in the form of a plurality of buttons or a touch screen integrated with the display device 16, is for receiving the input signal from the user.

According to the operations of the user, the input module 18 can generate corresponding control signals 48A and transmit the corresponding control signals 48A to the processing module 14 so that the processing module 14 can receive the input signals from the user and then operate the corresponding functional schematic blocks. The display device 16, which can be designed in the form of a liquid crystal display, transforms related information transmitted from the processing module 14 into video data for the user.

For wireless communication, a base-band circuit 42 and a RF circuit 44 are installed in the wireless communication module 40. The base-band circuit 42 can transform the electrical communication signals transmitted from the processing module 14 into proper base-band signals that are transmitted to RF circuit 44 afterwards. The RF circuit 44 modulates the base-band signals and then wirelessly transmits the modulated signals to other wireless communication devices. Additionally, the RF circuit 44 can receive wireless signals to demodulate the signals to base-band signals, which will be decoded into communication signals 48E by base-band circuit 42. Finally, the communication signals 48E will be transmitted to the processing module 14.

When the user starts to operate wireless communication by the mobile phone, the voice waves from the user will be transformed into sound signals 48B through the microphone 34 and then the sound signals 48B will be transmitted to the processing module 14. The processing module 14 is capable of transmitting the sound signals 48B to the wireless communication module 40 in order to wirelessly transmit the sound signals 48B to other wireless communication devices. Therefore, the voice waves from the user can be wirelessly transmitted through the mobile phone 10. On the other hand, after the wireless communication module 40 receives the wireless communication signals, the processing module 14 will transform the wireless communication signals into voice signals 48C that the speaker 36 transforms into corresponding voice waves so that the user can receive the information through the wireless communication apparatus.

A distinguishing characteristic of the present invention is the application of the interactive scent interface. For achieving the functions of the interactive scent interface, a scent control circuit 20 and a scent releasing module 22 are installed in the present invention. For supplying the source of the scent, a scent storage media 26 is designed for storing the scent particles. In the scent releasing module 22, a scent releaser 24 is connected to the scent storage media 26 for releasing the scent particles stored in the scent storage media 26 so that the user can smell the scent corresponding to the scent particles. The scent storage media 26 can be designed in the form of a liquid scent storage media or solid scent storage media. Powered by the power supply circuit 52, the scent releaser 24 releases the scent particles stored in the scent storage media 26 by heating the scent storage media 26 or by vibrating the scent storage media 26 with ultrasonic waves. The scent particles are vaporized out of the scent storage media 26 by heating and be released out of the scent storage media 26 by vibrating the scent storage media 26 with ultrasonic waves.

Because the scent particles stored in the scent storage media 26 are consumed gradually with use, the scent storage media 26 is detachably installed in the mobile phone 10. Referring to the three applications as shown in FIG. 1, if the scent storage media 26 is solid scent storage media, the scent storage media 26 can be directly installed in the mobile phone 10 or can be accommodated within a cartridge 28. If the scent storage media 26 is a liquid scent storage media, it also can be accommodated within a cartridge 28. In other words, whether the scent storage media 26 is solid or liquid scent storage media, all the scent storage media 26 storing different scent particles can be accommodated within the same cartridge 29 in order to conveniently replace a plurality of scent storage media 26. A corresponding slot 30 is installed in the mobile phone 10 for fixing the scent storage media and the cartridge.

Referring to the schematic embodiment as shown in FIG. 1, three releasing ends 32 are installed in the scent releaser 24 to respectively drive three different scent storage media 26 to release scent particles. The scent releaser 24 can drive any one of releasing ends 32 to drive the corresponding scent storage media 26 for releasing specific scent particles according to the scent control signal from the scent control circuit 20. As shown in FIG. 2, an opening gate 56 is installed in the housing 12 for installing the scent storage media or the cartridge. Moreover, a plurality of apertures 54 as shown in FIG. 2 are installed in the housing 12, such that the users can smell the scent corresponding to the scent particles.

The operations of the interactive scent interface of the present invention can be described as follows: the processing module 14 can control the scent control circuit 20 to generate a scent control signal 48F, and the scent releaser 24 can optionally drive the scent storage media to release the scent particles according to the scent control signal 48F.

Additionally, the processing module 14 also can store a scent module data 50 in the memory device 46 in order to record the related data and parameters concerning the operations of the interactive scent interface. The scent control circuit 20 is controlled according to the scent module data 50. For example, the user of the mobile phone 10 is able to set various scents corresponding to different friends in advance through the input module 18, and the processing module 14 will store the related data in the scent module data 50. When a member in the setting list of the user contacts user by the mobile phone 10 through wireless telecommunication, the processing module 14 can judge the identification of the caller and find out the pre-set data related to the friend according to the scent module data 50. After that, the processing module 14 can drive the scent releasing module 22 to release the corresponding scent through the scent control circuit 20.

The mobile phone of prior art comprises the visionary function of “calling display” or the hearing function of “calling recognition”, so that the various callers will correspond to different images being displayed or different bell ringing. The present invention is able to perform the function of “calling recognition” with various scents. Therefore, the users of the mobile phone 10 can rely on the scent to recognize different callers according to various scents released from the scent releasing module 22.

Another usage of the scent releasing module of the present invention can be described as follows: When another user contacts the user of the mobile phone 10 by a remote mobile phone through the mobile phone 10 in the wireless communication system, the user of the remote mobile phone can transmit a scent control signal to the mobile phone 10 through the wireless communication system. After the scent control signal is received by the mobile phone 10, the processing module 14 can control the scent control circuit 20 to generate a corresponding scent control signal 48F and to release the corresponding scent from the scent releasing module 22. Namely, the user of the remote mobile phone can control the scent releasing module 22 of the mobile phone 10 through wireless telecommunication to make the user of the mobile phone 10 smell the remote-user-specified scent for entertainment.

In the prior art, the user of the remote mobile phone can deliver a short message to a specified mobile phone through wireless telecommunication, and the short message will be transformed to characters on that display screen of the specified mobile phone to make that user of the specified mobile phone recognize the short message. The scent releasing module 22 of the present invention achieves the function of short scent message, which make the user of the remote mobile phone able to contact the user of the mobile phone 10 with the scent through wireless communication. Certainly, the function of the short scent message of the present invention can be integrated with the conventional functions of short message and speech communication in the prior art to provide the integrated sight, sound, and olfactive interactive scent interface at the same time.

In practice, the processing module 14 of the mobile phone 10 also can make use of the wireless communication module 40 to generate the scent module data 50 in the memory device 46 through wireless communication. The user of the remote mobile phone will be reminded how to deliver the scent short message related to the scent releasing module 22 of the mobile phone 10 from the remote mobile phone after the user of the remote mobile phone receives the related scent module data.

For example, the processing module 14 of the mobile phone 10 can record and categorize the various scent storage media 26, which are installed in the scent releasing module 22, into the scent module data 50, and deliver these data to the remote mobile phone through wireless communication sometimes by request of the remote mobile phone. The user of the remote mobile phone can be informed to release a specific scent to the user of the mobile phone 10 through the mobile phone 10 after the user of the remote mobile phone receives the related data. In other words, the user of the remote mobile phone can choose one or a number of scents, and then transmit relevant scent control signals from the remote the mobile phone to the mobile phone 10 through wireless communication to make the user of the mobile phone 10 smell the remote-user-specified short scent message.

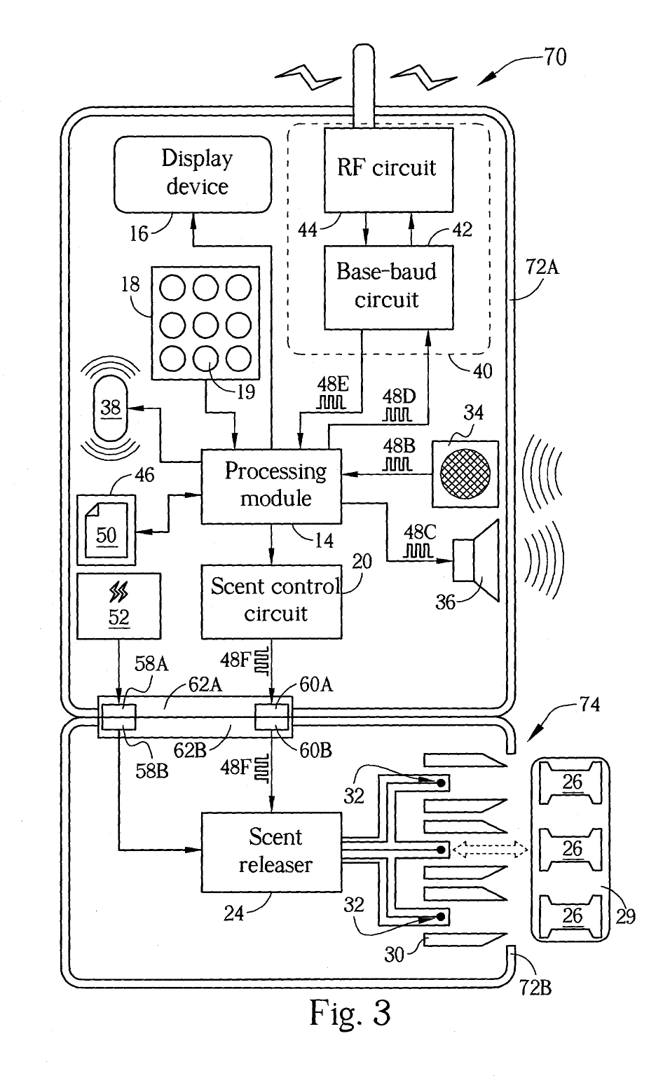

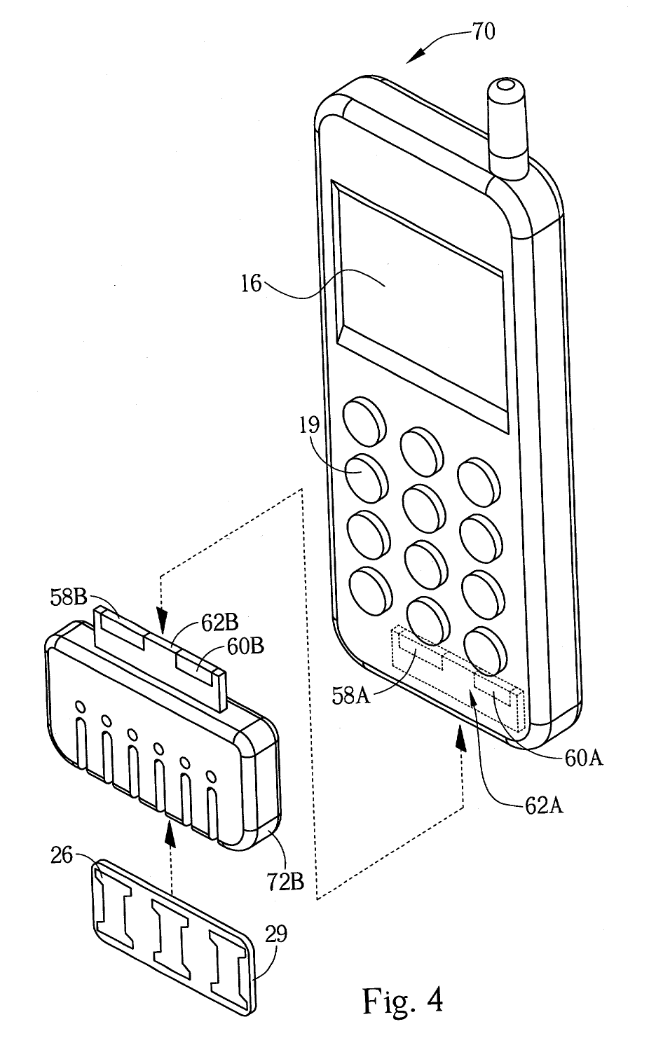

Please Refer to FIG. 3 and FIG. 4. FIG. 3 is a functional block diagram of another embodiment of a mobile phone 70 according to the present invention and FIG. 4 is an externally schematic diagram of the mobile phone 70. For simplification in the following instructions, the devices as shown in FIG. 3 and FIG. 4 which are labeled the same with those in FIG. 1 and FIG. 2 are designed with the same operation functions, such as the processing module 14, the wireless communication module 40; the display device 16, the input module 18, the scent control circuit 20, the microphone 34, the speaker 36, the vibration module 38, the memory device 46, and the power supply circuit 52.

The scent releaser 24 is also installed in the scent releasing module 74 of the mobile phone 70 to drive the scent storage media 26 into releasing the scent. One main distinction between the mobile phone 70 and the mobile phone 10 is that the scent releasing module 74 of the mobile phone 70 is an independent module covered by the housing 72B and installed detachably in the housing 72A of the body of the mobile phone 70. In order to connect the scent releasing module 74 and the the mobile phone 70, corresponding detachable electric power ports 58A and 58B and the detachable signal ports 60A and 60B are installed in the housing 72A and 72B respectively.

After the electric power ports 58A and 58B are connected, the electric power supplied by the power supply circuit 52 can be delivered to the scent releasing module 74. After the signal ports 60A and 60B are connected, the scent control signal 48F can be delivered to the scent releasing module 74 by the scent control circuit 20.

For expanding the functions of the mobile phone, today”s mobile phones are generally designed with connection ports for the sake of expansion to exchange signals and electric power with other devices through connection ports. For instance, some of the mobile phones available on the market are able to connect to a digit camera. In the embodiment of FIG. 3 and FIG. 4, the detachably independent scent releasing module 74 can make use of the pre-existed connection ports to detachably connect to the body of the mobile phone 70 so that the user of the mobile phone 70 is able to easily expand the functions of the mobile phone 70 to include the interactive scent interface.

Because current mobile phones have the capability of simultaneous transmission of electric power and signals, the connection port 62B, which is integrated with electric power port 58B and the signal port 60B, can be installed in the scent releasing module 74 of the present invention in order to integrate with the connection port 62A, which is integrated with the electric power port 58A and the signal port 60A. Additionally, the invention also can integrate the scent control circuit 20 and the scent releaser 24 with the scent releasing module 74. The processing module 14 can control the scent control circuit 20 by electrically connecting to the signal ports 60A and 60B. Certainly, the scent releasing module 74 also can be established with its own electric power supply circuit, such as a battery, to supply the power for operating the scent releasing module 74 in order to reduce the burden of power supply circuit 52 of the mobile phone 70.

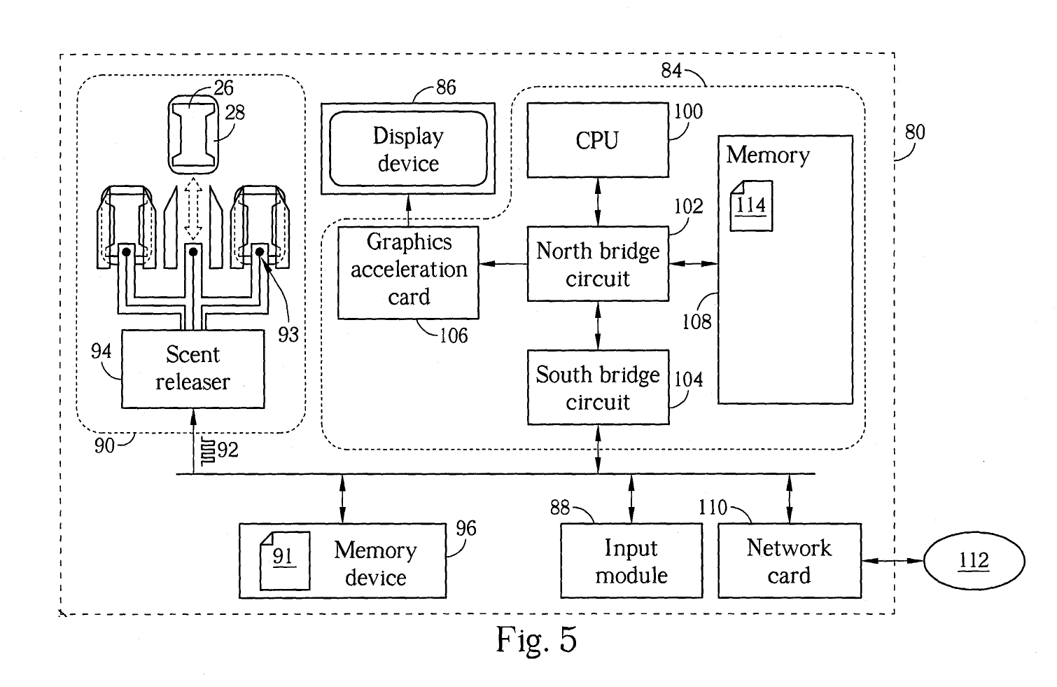

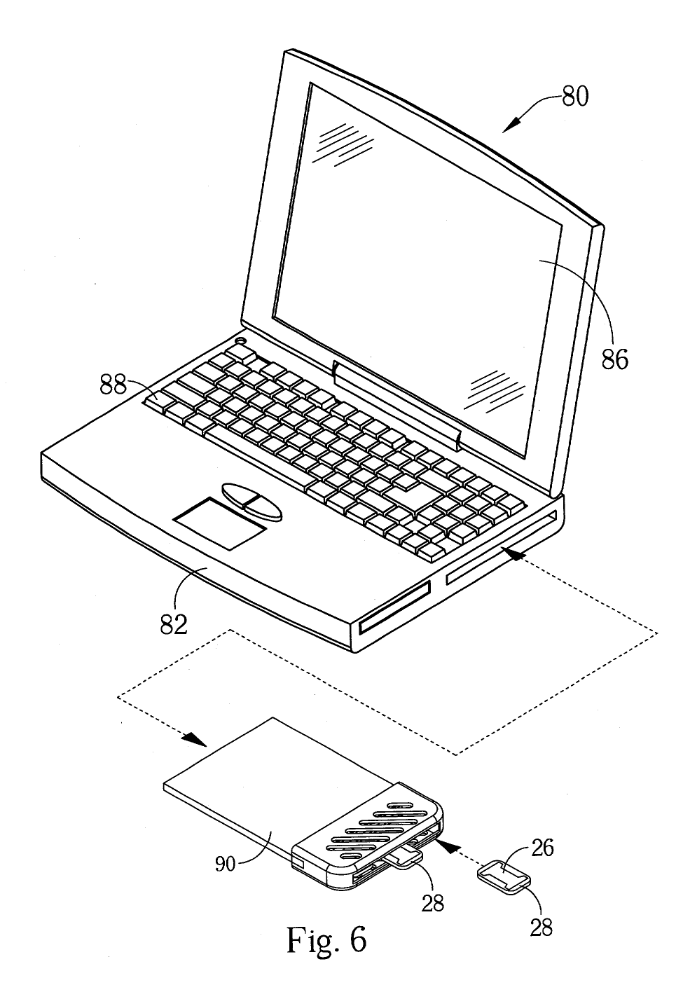

Please refer to FIG. 5 and FIG. 6. FIG. 5 is a functional block diagram of the embodiment of a computer 80 according to the present invention. FIG. 6 is an externally schematic diagram of the computer 80. The computer 80 can be a notebook or a desktop computer. The computer 80 comprises a display device 86 (such as a liquid crystal display) and a housing 82 (as shown in FIG. 6) inside which a processing module 84, an input module 88, a memory device 96, and a scent releasing module 90 are installed. The processing module 84, which controls the operations of the computer 80, comprises a central processing unit (CPU) 100, a north bridge circuit 102, a south bridge circuit 104, a graphics acceleration card 106, and a memory 108.

The CPU 100 is the nucleus of the computer 80 for information processing. The memory 108, which can be a volatile random access memory, is used to store the data temporarily. The north bridge circuit 102 is designed for managing the transmission of data between the memory 108, the graphics acceleration card 106 and the CPU 100. The data from the CPU 100 can be presented as graphic images on the display device 86 through the graphics acceleration card 106. The south bridge circuit 104 can manage the CPU 100 and the transmission of data between accessory devices through the bus. The accessory devices can include the input module 88 (such as a keyboard, a mouse, or a touch-pad) and the memory device 96 (such as a non-volatile hard-disk, optical disk, and so on). The computer 80 can also be installed with a network card 110 to make a wired or wireless link between the computer 80 and a network 112. The user can deliver the control signal to the processing module 84 through the input module 88 to operate the computer 80.

One of the special characteristics of the invention is to realize the interactive scent interface by the scent releasing module 90. The scent releasing module 90, which is, connected to the processing module 84, can accept a control the signal 92 from the processing module 84. All the releasing ends 93 of a scent releaser 94 are designed to concentrate energy in different scent storage media 26 of each cartridge 28 to release the scent particles stored in different scent storage media 26 for accomplishing the interactive scent interface of the present invention.

In the computer 80, the scent releasing module 90 can operate in coordination with a driving program 114. When the interactive scent interface of the invention begins to operate, the processing module 84 can load the driving program 114 into the memory 108, and then the CPU 100 can execute the driving program 14 to generate the scent control signal 92. In other words, after the CPU 100 executes the driving program 114, the CPU 100 can be viewed as a scent control circuit for controlling the scent releasing module 90 on the equivalence. In practice, the scent releasing module 90 can connect to the processing module 84 by the way of detachable insertion. For example, the scent releasing module 90 can be made in the form of a peripheral communications interface bus (PCI) card and be connected to the processing module 84 by a PCI slot for obtaining the electric power and receiving the control signal of the processing module 84. Moreover, the scent releasing module 90 can also be an external connected device connected to the processing module 84 through the connection ports (such as a Universal Serial Bus (USB) or a Personal Computer Memory Card International Association (PCMCIA) slot for a notebook) to accept the control signal from the processing module 84 and to obtain the electric power for operation. If the scent releasing module 90 is established with the independent power supply, such as the battery, or with the ability of independently obtaining the electric power for operation (for example, the scent releasing module 90 can connect to the general domestic power source to obtain the power), the scent releasing module 90 can acquire only the scent control signal 92 from the processing module 84. In the above-mentioned circumstances, the scent control signal 92 can be delivered to the independently established scent releasing module 90 by infrared rays or other wireless communication signals, and the interactive scent interface can be accomplished. Similar with the two above-mentioned embodiments of the present invention, the processing module 84 also can store the related data concerning the operations of the scent releasing module 90 (such as the categories of the scent storage media installed in the scent releasing module) in the memory device 96 with the form of a scent control data 91.

In coordination with the operations of the driving program 114, the computer 80 of the present invention can realize various types of the interactive scent interfaces. For instance, the interactive interface of the prior art comprise a so-called “force feedback” pointing device, which is designed to let the user perceive vibrations to different degrees along with the user performing different kinds of operations for the computer. The “scent-feedback” interactive scent interface can be accomplished by the scent releasing module 96 of the present invention. For example, a game program can access and store the scent resources provided by the driving program 114 through the computer 80. Along with the user executing the game program to different extents, the game program is able to drive the scent releasing module 90 to release various scents through the driving program 114 for increasing the interaction and fun.

Additionally, if the media broadcast program also can match the driving program 114, the scent releasing module 90 can release the corresponding scent particles along with the playing of the images and sounds. Thus, the user will have updated fresh, interesting, and diverse feelings. In coordination with the time-arrangement programs in the present computer, the user will be reminded with the corresponding scent at specific time when operating the computer 80. For instance, the user can arrange the specific time for a specific task or meeting in advance with a time-arrangement program, such as Outlook from Microsoft, and then the time-arrangement program will access the scent resources supplied by the driving program 114 to remind the user with the specific scent.

Similar with the first two embodiments of the present invention, when the user of the computer 80 contacts the network 112 through the network card 110, the scent can be used as the interactive scent interface during the process of network communication. For example, when there is an E-mail transmitted through the network 112, the E-mail managing program of the computer 80 can remind the user with the specific scent through the driving program 114. When the user of the computer 80 performs real-time communication through the network 112 (such as ICQ), the user of the remote computer also can realize the scent resources of the computer 80 through the management of the real-time communication program (for example, the scent control data 91 is transmitted to the remote computer or the real-time management server by request of the communication program in the computer 80 through the network 112), and transmit the related scent control signals to the computer 80 through the network 112. Thus, the user of the remote computer can make the user of the computer 80 smell the specific scent through the operations of the scent releasing module 90.

Moreover, a web page in the network can de designed as the new-type interactive scent interface making use of the scent releasing module of the computer 80. The builder of the web page can set up the suitable scent resource access program in the web page. When the user of the computer 80 browses the web page with a browsing program of the computer 80, the scent resource access program will be downloaded to the computer 80 through the network 112. When the browsing program of the computer 80 starts to execute the scent resource access program, the driving program 114 of the scent releasing module 90 will be started, and the user of the computer 80 can browse the web page with the scent specified by the builder of the web page so that the browser of the web page will have diverse and fresh experiences.

In contrast to the prior art, the present invention can make use of interactive scent operations for expanding perceptive experiences and for providing diverse operating interfaces. Referring to the apparatus of the prior art, the interface between the users and the apparatus only uses the senses of sight, hearing, and touch as the operating interface lacking of the fun and friendliness for users. In the present invention, the interactive scent interface can be practically accomplished with a plurality of embodiments of the scent releasing modules, and the information processing apparatus thus can become closer to real life experiences. The present invention can be widely used in the data processing devices, including the mobile phone, the personal digital assistant module (PDA), the notebook, the desktop computer, and so on, for a practical realization of the interactive scent interface.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. An information processing apparatus comprising:
a housing;
a processing module installed in the housing for controlling the information processing apparatus;
an input module installed in the housing and electrically connected to the processing module for receiving input signals to generate corresponding control signals and for transmitting the corresponding control signals to the processing module;
a display device installed in the housing and electrically connected to the processing module for transforming information transmitted from the processing module into video data and for displaying the video data;
a scent control circuit installed in the housing and electrically connected to the processing module for generating a scent control signal; and
a scent releasing module installed in the housing and electrically connected to the scent control module for releasing scent particles according to the scent control signal, such that a user can smell scent corresponding to the scent particles.

2. The information processing apparatus of claim 1 wherein the scent releasing module comprises:
a scent storage media for storing the scent particles; and
a scent releaser connected to the scent storage media for releasing the scent particles stored in the scent storage media according to the scent control signal.

3. The information processing apparatus of claim 2 wherein the scent storage media is liquid scent storage media.

4. The information processing apparatus of claim 2 wherein the scent storage media is solid scent storage media.

5. The information processing apparatus of claim 2 wherein the scent releaser releases the scent particles stored in the scent storage media by heating the scent storage media.

6. The information processing apparatus of claim 2 wherein the scent releaser releases the scent particles stored in the scent storage media by vibrating the scent storage media with ultrasonic waves.

7. The information processing apparatus of claim 2 wherein the scent storage media is accommodated within a cartridge.

8. The information processing apparatus of claim 7 wherein the scent releaser is fixed inside the housing and the cartridge is detachably connected to the scent releaser.

9. The information processing apparatus of claim 7 wherein the cassette is capable of accommodating a plurality of scent storage media, each scent storage media storing particles of different scent.

10. The information processing apparatus of claim 1 wherein the scent releasing module is detachably installed in the housing.

11. The information processing apparatus of claim 1 furthering comprising a wireless communication module electrically connected to the processing module for receiving wireless signals so as to generate corresponding communication signals and for transmitting the communication signals to the processing module.

12. The information processing apparatus of claim 111 wherein the processing module is capable of controlling the scent control circuit according to the communication signals so as to enable the scent control circuit to generate scent control signals corresponding to the communication signals.

13. The information processing apparatus of claim 11 wherein the wireless communication module is further capable of wirelessly transmitting information transmitted from the processing module to other wireless communication devices.

14. The information processing apparatus of claim 13 further comprising a microphone electrically connected to the processing module for transforming voice waves into sound signals and for transmitting the sound signals to the processing module, and the processing module being capable of controlling the wireless communication module to wirelessly transmit the sound signals to other wireless communication devices.

15. The information processing apparatus of claim 11 further comprising a speaker electrically connected to the processing module for transforming information transmitted from the processing module into voice waves.

16. The information processing apparatus of claim 15 wherein the processing module is capable of controlling the speaker to transform the communication signals into corresponding voice waves according to the communication signals.

17. The information processing apparatus of claim 1 further comprising a memory electrically connected to the processing module for storing information.

18. The information processing apparatus of claim 17 wherein the memory is capable of storing scent module information corresponding to operation states of the scent releasing module.

19. The information processing apparatus of claim 18 wherein the scent releasing module further comprising a scent storage media for storing the scent particles, and the scent module information is used for recording type information of the scent particles.

20. The information processing apparatus of claim 18 further comprising a wireless communication module electrically connected to the processing module for wirelessly transmitting information transmitted from the processing module to other wireless communication devices.

21. The information processing apparatus of claim 20 wherein the processing module is capable of transmitting the scent module information to the wireless communication module, and the wireless communication module then wirelessly transmitting the scent module information to other wireless communication devices.

22. The information processing apparatus of claim 17 wherein the memory stores data in a non-volatile way

23. The information processing apparatus of claim 1 being a mobile phone.

24. The information processing apparatus of claim 1 being a computer.

25. The information processing apparatus of claim 1 being a notebook computer.
